(19) United States
(12) Patent Application Publication
(10) Pub. No.: US 2018/0139464 A1
(43) Pub. Date: May 17, 2018

(54) DECODING SYSTEM FOR TILE-BASED VIDEOS

(71) Applicant: MEDIATEK INC., Hsin-Chu City (TW)

(72) Inventors: Min-Hao CHIU, Hsinchu City (TW); Ping Chao, Taipei City (TW); Chia-Hung Kao, Tainan City (TW); Huei-Min Lin, Zhubei City (TW); Hsiu-Yi Lin, Taichung City (TW); Chi-Hung Chen, Hsinchu City (TW); Chia-Yun Cheng, Zhubei City (TW); Chih-Ming Wang, Zhubei City (TW); Yung-Chang Chang, New Taipei City (TW)

(73) Assignee: MEDIATEK INC., Hsin-Chu City (TW)

(21) Appl. No.: 15/803,388

(22) Filed: Nov. 3, 2017

Related U.S. Application Data
(60) Provisional application No. 62/423,221, filed on Nov. 17, 2016.

(51) Int. Cl. H04N 19/44; H04N 19/423; H04N 19/172

(52) U.S. Cl. CPC H04N 19/44; H04N 19/172; H04N 19/423

(57) ABSTRACT

Aspects of the disclosure provide a video decoding system. The video decoding system can include a decoder core configured to selectively decode independently decodable tiles in a picture, each tile including largest coding units (LCUs) each associated with a pair of picture-based (X, Y) coordinates or tile-based (X, Y) coordinates, and memory management circuitry configured to translate one or two coordinates of a current LCU to generate one or two translated coordinates, and to determine a target memory space storing reference data for decoding the current LCU based on the one or two translated coordinates.

### INCORPORATION BY REFERENCE

This present disclosure claims the benefit of U.S. Provisional Application No. 62/423,221, “Novel Decode System” filed on Nov. 17, 2016, which is incorporated herein by reference in its entirety.

### TECHNICAL FIELD

The present disclosure relates to video decoding techniques for decoding videos that include independently encoded tiles. The videos can be omnidirectional videos or virtual reality videos.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Users can view a virtual reality or omnidirectional (VR/360) video with a head mounted display (HMD), and move their heads around the immersive 360 degree space in all possible directions. At a time instant, only a portion of the immersive environment in the field of view (FOV) of the HMD is displayed. Tile based coding techniques, as specified in some video coding standards, can be employed for processing the VR/360 video to reduce transmission bandwidth or decoding complexity.

### SUMMARY

Aspects of the disclosure provide a video decoding system. The video decoding system can include a decoder core configured to selectively decode independently decodable tiles in a picture, each tile including largest coding units (LCUs) each associated with a pair of picture-based (X, Y) coordinates or tile-based (X, Y) coordinates, and memory management circuitry configured to translate one or two coordinates of a current LCU to generate one or two translated coordinates, and to determine a target memory space storing reference data for decoding the current LCU based on the one or two translated coordinates.

In one embodiment, the memory management circuitry is configured to translate a picture-based X coordinate of the current LCU to a tile-based X coordinate according to an expression of

tile-based X coordinate=picture-based X coordinate−tile X offset,

wherein the tile X offset is a picture-based X coordinate of a start position of a current tile including the current LCU. In an example, the video decoding system can further include a first memory including a plurality of memory spaces for storing top neighbor reference data of the current tile. Each memory space can correspond to an LCU column of the current tile. Accordingly, the memory management circuitry can be configured to determine one of the plurality of memory spaces in the first memory to be the target memory space storing top neighbor reference data for decoding the current LCU according to the translated tile-based X coordinate. The top neighbor reference data of the current tile is not used for decoding other tiles in the picture in one example.

In an embodiment, the memory management circuitry is configured to translate a pair of tile-based (X, Y) coordinates to a pair of picture-based (X, Y) coordinates according to following expressions,

picture-based X coordinate=tile-based X coordinate+tile X offset, and

picture-based Y coordinate=tile-based Y coordinate+tile Y offset,

wherein the tile X offset is a picture-based X coordinate of a start position of a current tile including the current LCU, and the tile Y offset is a picture-based Y coordinate of the start position of the current tile including the current LCU.

In one example, the memory management circuitry is configured to determine a memory space in one of second memories to be the target memory space storing the reference data for decoding the current LCU according to the translated picture-based (X, Y) coordinates. The second memories can include a reference picture memory configured to store a reference picture for decoding the current tile, a collocated motion vector memory configured to store motion vectors of a collocated tile in a previously decoded picture with respect to the current tile, or a segment identity (ID) memory configured to store segment IDs of blocks of a previously decoded picture.

In one example, the decoder core includes a module that includes the memory management circuitry, and is configured to read the reference data for decoding the current LCU from the target memory space. In an embodiment, the video decoding system can further include a third memory configured to store selectively decoded tiles of the picture.

In an embodiment, the video decoding system can include a first direct memory access (DMA) module and a second DMA module configured to read encoded tile data of different tiles of the picture in parallel from a bitstream of a sequence of pictures. Particularly, the decoder core can be configured to cause the first and second DMA modules to alternatively start to read the encoded tile data of different tiles.

Aspects of the disclosure provide a video decoding method. The method can include selectively decoding, by a decoder core, independently decodable tiles in a picture, each tile including largest coding units (LCUs) each associated with a pair of picture-based (X, Y) coordinates or tile-based (X, Y) coordinates, translating one or two coordinates of a current LCU to generate one or two translated coordinates, and determining a target memory space storing reference data for decoding the current LCU based on the one or two translated coordinates.

In an embodiment, the method further includes translating a picture-based X coordinate of the current LCU to a tile-based X coordinate according to an expression of

tile-based X coordinate=picture-based X coordinate−tile X offset,

wherein the tile X offset is a picture-based X coordinate of a start position of a current tile including the current LCU.

In an example, the method further includes determining one of a plurality of memory spaces in a first memory to be the target memory space storing top neighbor reference data for decoding the current LCU according to the translated tile-based X coordinate. The plurality of memory spaces is configured for storing top neighbor reference data of the current tile. Each memory space can correspond to an LCU column of the current tile.

In an embodiment, the video decoding method further includes translating a pair of tile-based (X, Y) coordinates to a pair of picture-based (X, Y) coordinates according to following expressions,

picture-based X coordinate=tile-based X coordinate+tile X offset, and

picture-based Y coordinate=tile-based Y coordinate+tile Y offset,

wherein the tile X offset is a picture-based X coordinate of a start position of a current tile including the current LCU, and the tile Y offset is a picture-based Y coordinate of the start position of the current tile including the current LCU.

The video decoding method can further include determining a memory space in one of second memories to be the target memory space storing the reference data for decoding the current LCU according to the translated picture-based (X, Y) coordinates. The second memories can include a reference picture memory configured to store a reference picture for decoding the current tile, a collocated motion vector memory configured to store motion vectors of a collocated tile in a previously decoded picture with respect to the current tile, or a segment identity (ID) memory configured to store segment IDs of blocks of a previously decoded picture.

Aspects of the disclosure provide a non-transitory computer-readable medium storing computer instructions that, when executed by one or more processors, cause the one or more processors to perform the video decoding method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a video decoding system according to an embodiment of the disclosure;

FIG. 2A shows a conventional decoding process for decoding a tile-based picture in a conventional decoding system;

FIG. 2B shows a decoding process for decoding a tile-based picture in the video decoding system according to an embodiment of the disclosure;

FIG. 3A shows an exemplary memory access scheme in the conventional decoding system described in FIG. 2A example;

FIG. 3B shows an exemplary memory access scheme according to an embodiment of the disclosure;

FIG. 4A shows an example of an output memory map of an output memory in the conventional decoding system;

FIG. 4B shows an example of an output memory map of the output memory in the video decoding system according to an embodiment of the disclosure;

FIG. 5A shows an example direct memory access (DMA) controller in the video decoding system according to an embodiment of the disclosure;

FIG. 5B shows an example process of reading tile data in parallel by the DMA controller according to an embodiment;

FIG. 6 shows a video decoding system according to an embodiment of the disclosure;

FIG. 7 shows an example decoding process for decoding a picture in the video decoding system in FIG. 6 according to an embodiment of the disclosure;

FIG. 8 shows a coordinate translation scheme according to an embodiment of the disclosure;

FIG. 9 shows a video decoding system according to an embodiment of the disclosure;

FIG. 10 shows an example video decoding process according to an embodiment of the disclosure; and

FIG. 11 shows an example video decoding process according to an embodiment of the disclosure.

### DETAILED DESCRIPTION OF EMBODIMENTS

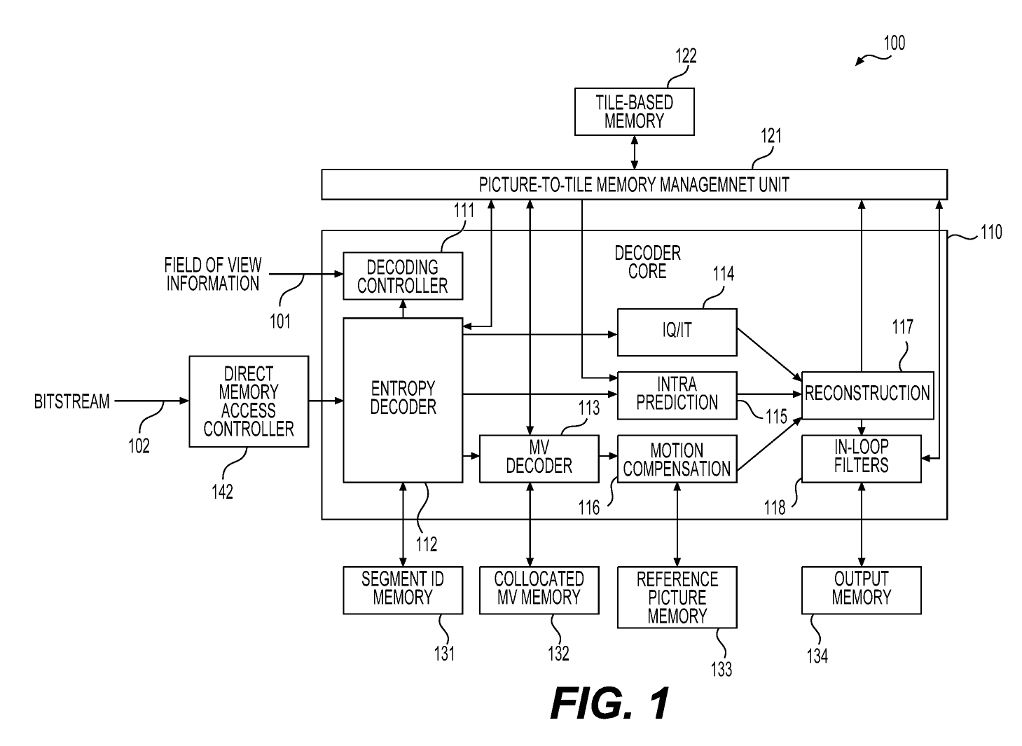

FIG. 1 shows a video decoding system 100 according to an embodiment of the disclosure. The video decoding system 100 can be configured to partially decode a picture including tiles that are encoded independently from each other. In one example, the video decoding system 100 can include a decoder core 110, a picture-to-tile memory management unit (P2T MMU) 121, a tile-based memory 122, a segment ID memory 131, a collocated motion vector (MV) memory 132, a reference picture memory 133, an output memory 134, and a direct memory access (DMA) controller 142. In one example, the decoder core 110 can include a decoding controller 111, an entropy decoder 112, a MV decoder 113, an inverse quantization and inverse transformation (IQ/IT) module 114, an intra prediction module 115, a motion compensation module 116, a reconstruction module 117, and one or more in-loop filters 118. Those components are coupled together as shown in FIG. 1.

The video decoding system 100 can be configured to decode an encoded video sequence carried in a bitstream 102 to generate decoded pictures. Particularly, pictures carried in the bitstream 102 can each be partitioned into tiles that are encoded independently from each other. Accordingly, the video decoding system 100 can decode each tile in a picture independently without referring to neighbor reference data of neighboring tiles. As a result, memory space for storing neighbor reference data can be reduced.

For example, in a conventional video decoding system for decoding a picture including tiles that are not encoded independently from each other, neighbor reference data corresponding to multiple tiles in a tile row need to be stored for decoding tiles in a next tile row. In contrast, in the video coding system 100 for decoding tiles that are encoded independently, the tile-based memory 122 can be configured to store neighbor reference data corresponding to one current tile, but no memory is needed for storing neighbor reference data of previously-processed tiles. As a result, memory space for storing neighbor reference data in the video coding system 100 can be reduced compared with the conventional video decoding system for decoding pictures including dependently encoded tiles.

In addition, the video coding system 100 can be configured to operate using picture based coordinates. For example, each tile can be partitioned into rows and columns of largest coding units (LCUs) each associated with a pair of picture-based (X, Y) coordinates. The tile-based memory 122 can include multiple memory spaces each corresponding to an LCU column in a currently-being-processed tile (referred to as a current tile). When an LCU in the current tile is being processed (the LCU is referred to as a current LCU), a coordinate translation can be performed on a picture-based X coordinate of the current LCU to generate a tile-based X coordinate indicating an LCU column including the current LCU. Accordingly, a target memory space corresponding to this current LCU can be located based on the translated X coordinate. Subsequently, the determined target memory space in the tile-based memory 122 can be accessed to write or read neighbor reference data related with the current LCU.

Further, as tiles in the pictures carried in the bitstream 102 can be decoded independently, the video coding system 100 can be configured to selectively decode tiles in a picture. Or, in other words, a picture can be partially decoded when only a portion of the tiles of the picture are decoded, or fully decoded when all tiles of the picture are decoded. For example, in virtual reality or omnidirectional (VR/360) video applications, in order to display a field of view (FOV) of a head mounted display (HMD) device, the video coding system 100 can be configured to only select tiles overlapping the FOV to decode. A resultant partially decoded picture can include a subset of tiles in the picture instead of all the tiles in the picture. As a result of this partial decoding, the output memory 134 that is used for buffering output pictures can be reduced compared with storing fully decoded pictures.

The decoder core 110 can be configured to receive encoded data carried in the bitstream 102 and decode the encoded data to generate fully or partially decoded pictures. In different examples, the bitstream 102 can be a bitstream conforming to one of various video coding standards, such as the high efficiency video coding (HEVC) standard, the VP9 standard, and the like. The decoder core 110 can decode the encoded data accordingly by using decoding techniques corresponding to the respective video coding standard in different examples. The video coding standards adopted for generating the bitstream 102 can typically support tiles in video processing. For example, as specified in related video coding standards, a picture can be partitioned into rectangular regions, referred to as tiles, that are independently decodable. Each tile in a picture can include approximately equal numbers of blocks, such as coding tree units (CTUs) as in HEVC or super blocks as in VP9. A CTU or super block can be referred to as a largest coding unit (LCU) in this specification. An LCU can further be partitioned into smaller blocks as can be separately processed in various coding operations.

In addition, the encoded video sequence carried in the bit stream 102 can have a coding structure that supports partially decoding pictures. As an example, in the encoded video sequence, every N picture can include a master picture followed by N−1 slave pictures. Each master picture can be used as a reference picture for predictively encoding neighboring slave pictures or other master pictures that precedes or follows the master picture. In contrast, slave pictures are not allowed to be used as reference pictures. When the encoded video sequence is being decoded at the decoder core 110, a master picture can be fully decoded and stored in the reference picture memory 133 that can be later used for decoding other neighboring slave pictures or master pictures. In contrast, slave pictures can be partially decoded, and tiles of the partially decoded slave pictures can be stored in the output memory 134 waiting for be displayed but not used as data of reference pictures.

The decoding controller 111 can be configured to control and coordinate decoding operations in the decoder core 110. Particularly, in one example, the decoding controller 111 can be configured to determine a subset of tiles in a picture for partially decoding the picture. For example, the decoding controller 111 can receive FOV information 101 from an HMD indicating a region of a VR/360 video being displayed. On the other side, the decoding controller 111 can obtain tile partition information of the picture from a high-level syntax received from the entropy decoder 112 or software parsing. Based on the tile partition information and the FOV information 101, the controller 111 can determine a subset of tiles in the picture that overlaps the region being displayed.

Subsequently, the decoding controller 111 can command the DMA controller 142 to read encoded data corresponding to the selected tiles in the picture from the bit stream 102. For example, the bit stream 102 can carry encoded data of the video sequence being processed, and can be first received from a remote encoder and then stored in a local memory.

The entropy decoder 112 can be configured to receive encoded data from the DMA controller 142 and decode the encoded data to generate various syntax elements. For example, a high level syntax including picture tile partition information can be provided to the decoding controller 111, syntax elements including encoded block residues can be provided to the IQ/IT module 114, syntax elements including intra prediction mode information can be provided to the intra prediction module 115, while syntax elements including motion vector prediction information can be provided to the MV decoder 113.

Particularly, in one example, some syntax elements in the bitstream 102 can be encoded with context-based adaptive binary arithmetic coding (CABAC) method. In order to decode the syntax elements encoded with CABAC corresponding to a current block (an LCU or a smaller block), the entropy decoder 112 can be configured to select a probability model based on related side information in neighboring bocks that are previously decoded. Those related side information of neighboring blocks can be referred to as CABAC neighbor reference data corresponding to the neighboring blocks. Accordingly, when decoding CABAC-encoded syntax elements of a current LCU in a tile, the entropy decoder 112 can store the CABAC neighbor reference data corresponding to the current LCU to the tile-based memory 122 that can later be used for entropy decoding of blocks in an adjacent LCU in the same tile.

Further, in one example, the bitstream 102 can be encoded according to VP9 standard, and segmentation, as specified in VP9 standard, is configured for the encoded video sequence. For example, a plurality of segments may be specified for a picture. For each of these segments, a set of parameters for controlling encoding or decoding can be specified. For example, the set of parameters can include a quantization parameter, an in-loop filter strength, a prediction reference picture, and the like. Each block in a picture can be assigned a segmentation identity (ID) indicating the block's segment affiliation. Those segmentation IDs of a picture can form a segmentation map that may change between two pictures (such as a master picture and a slave picture referencing the master picture). Differences between such two segmentation maps can be calculated and entropy encoded.

Accordingly, the entropy decoder 112 can be configured to decode segmentation ID differences corresponding to a current LCU of a current picture, retrieve segmentation IDs of a collocated LCU in a previously decoded segmentation map from the segment ID memory 131, and subsequently generate segmentation IDs of the current LCU by adding the decoded segmentation ID differences to the retrieved segmentation IDs of the collocated LCU. The thus generated segmentation IDs of the current LCU in a master picture can then be stored into the segment ID memory 131 and later be used for decoding collocated LCUs in pictures referencing the master picture.

The MV decoder 113 can receive decoded motion vector differences from the entropy decoder 112 and reconstruct motion vectors accordingly. For example, motion vectors of blocks in an LCU can be predictively encoded with reference to motion vectors of neighboring blocks or motion vectors of a collocated block in a reference picture. Accordingly, based on the motion vector prediction information received from the entropy decoder 112, the MV decoder 113 can determine a motion vector candidate. The motion vector candidate can be one of neighboring motion vectors of blocks in a previously decoded adjacent LCU stored in the tile-based memory 122, or collocated motion vectors of blocks in a collocated LCU in a reference picture stored the collocated MV memory 132. Thereafter, a motion vector can be constructed based on a motion vector difference and the determined motion vector candidate. In addition, a reference picture index associated with the motion vector candidate can also be employed.

Subsequently, the MV decoder 113 can store decoded motion vectors of the current LCU to the tile-based memory 122 that can later be used for decoding motion vectors of blocks in an LCU adjacent to the current LCU. The decoded motion vectors of the current LCU stored to the tile-based memory 122 can be referred to as MV neighbor reference data. In addition, when a picture including the current LCU is a master picture, the MV decoder 113 can store decoded motion vectors of the current LCU into the collocated MV memory 132 that can later be used for decoding motion vectors of a collocated LCU in a future picture (a slave picture or another master picture) of a decoding order.

The motion compensation module 116 can receive a decoded motion vector and an associated reference picture index from the MV decoder 113, and retrieve a reference block corresponding to the received motion vector and reference picture index from the reference picture memory 133. The retrieved reference block can be used as a prediction of a current block and transmitted to the reconstruction module 117.

The intra prediction module 115 can receive intra prediction mode information from the entropy decoder 112, and generate a prediction of a current block in a current LCU that is transmitted to the reconstruction module 117. Particularly, in order to generate the prediction, the intra prediction module 115 can retrieve reference samples in a previously processed LCU adjacent to the current LCU from the tile-based memory 122. The retrieved reference samples can be referred to as intra prediction neighbor reference data. For example, the current block is a block adjacent to the previously processed LCU. The prediction of the current block can be generated based on the retrieved reference samples and the received intra prediction mode information.

The IQ/IT module 114 can received encoded block residues, and perform inverse quantization and inverse transformation processes to recover block residual signals that are provided to the reconstruction module 117.

The reconstruction module 117 can receive block residual signals from the IQ/IT 114 module, and block predictions from the intra prediction module 115 and the motion compensation module 116, and subsequently generate reconstructed blocks that are provided to the in-loop filters 118. Particularly, the reconstruction module 117 can store intra prediction neighbor reference data of a current LCU into the tile-based memory 122 that can later be used for processing intra predictively encoded blocks in an LCU neighboring the current LCU.

The in-loop filters 118 can receive reconstructed blocks and filter samples in the reconstructed blocks to reduce distortions of the blocks. The in-loop filers 118 can include one or more filters, such as a deblocking filter, a sample adaptive offset filter, and the like. Filtering of different types of filters can be performed successively. In one example, the in-loop filters 118 can perform filtering on an LCU basis. Typically, filtering of samples along boundaries of a current LCU requires neighbor samples belonging to LCUs neighboring the current LCU. For example, a filtering process on a current LCU may be performed from top to bottom and right to left.

Accordingly, top neighbor samples belonging to a previously processed LCU and adjacent to a top boundary of a current LCU can be retrieved from the tile-based memory 121 in order to perform filtering on the retrieved samples and samples of the current LCU near the top boundary. For samples near a bottom boundary of the current LCU, because neighbor samples belonging to an LCU below the current LCU are not available yet, those samples near the bottom boundary can be stored into the tile-based memory 122 and later retrieved for processing the LCU below the current LCU. The samples near the bottom boundary and being stored into the tile-based memory 122 can be referred to as filter neighbor reference data corresponding to the current LCU.

The output memory 134 can be used for storing reconstructed tiles of partially or fully decoded pictures that can be subsequently displayed at a display device. Fully decoded pictures can be copied into the reference picture memory 133 and used as reference pictures. In alternative examples, the reference picture memory 133 and the output memory 134 can share a same memory space. Thus, only one copy of fully decoded pictures is maintained.

The P2T MMU 121 can be configured to perform a coordinate translation to facilitate memory access (read or write) to a target memory space in the tile-based memory 122. In one example, the decoder core 110 can be configured to operate using picture based coordinates. For example, LCUs within each tile can be associated with a pair of picture-based X and Y coordinates. On the other side, multiple memory spaces can be configured in the tile-based memory space for storing neighbor reference data corresponding to different LCUs within a current tile. The P2T MMU 121 can perform the coordinate translation to translate a picture-based X or Y coordinate of an LCU to a tile-based X or Y coordinate. Based on the translated tile-based X coordinate, a corresponding memory space storing neighbor reference data useful for decoding the respective LCU can be determined.

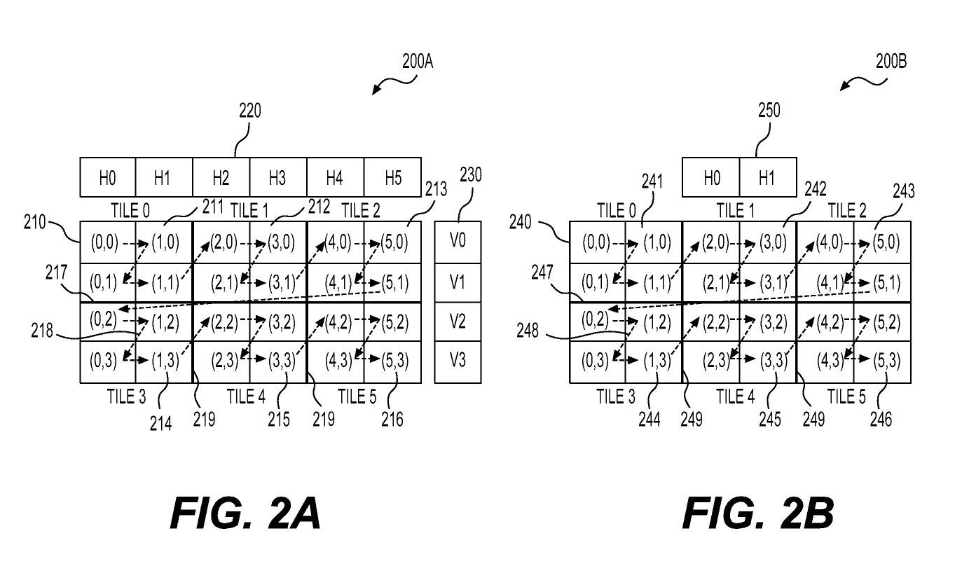

FIG. 2A shows a conventional decoding process 200A for decoding a tile-based picture 210 in a conventional decoding system. The picture 210 can be partitioned into six tiles, from Tile 0 to Tile 5 labeled with numbers from 211 to 216, and tile boundaries 217 and 219 exist between the tiles 211-216. Different from pictures processed in the FIG. 1 example, the tiles 211-216 in the picture 210 can be dependently encoded. In other words, data references can be performed across tile boundaries when encoding the picture 210. Each tile 211-216 can further includes 4 LCUs. The LCUs are each indicated with a pair of picture-based (X, Y) coordinates with respect to an origin located at a top-left corner of the picture 210. For example, the Tile 0 includes four LCUs having coordinates of (0, 0), (1, 0), (0, 1), (1, 1). During the decoding process 200A, the tiles can be processed in raster scan order as indicated by arrows 218 in FIG. 2A, and the LCUs in each tile can also be processed in raster scan order.

When processing of a current LCU, some decoding operations may need to use top or left neighbor reference data located in neighboring LCUs (top neighboring LCU or left neighboring LCU). For example, CABAC entropy decoding may reference side information in top or left neighboring blocks, decoding of predictively encoded motion vectors may reference candidate motion vectors in top or left neighboring LCUs, intra prediction processing may need top or left neighboring samples for generate a prediction of block, and in-loop filtering processing may need several lines of samples in top or left neighboring LCUs. As cross tile boundary data reference is employed when encoding the tiles 211-216, decoding of the tiles 211-216 needs to reference neighbor reference data across tile boundary accordingly.

To facilitate usage of neighbor reference data, a first memory 220 for storing top neighbor reference data and a second memory 230 for storing left neighbor reference data can be employed. The first and second memories 220 and 230 can be referred to as horizontal memory (H-memory) and vertical memory (V-memory), respectively. The H-memory 220 can include six memory spaces, represented as H0-H5, each corresponding to one of six LCUs in each row of the picture 210. The V-memory 230 can include four memory spaces, represented as V0-V3, each corresponding to one of four LCUs in each column of the picture 210.

During the decoding process 200A, when processing each row of LCUs (except the last row) in the picture 210, neighbor reference data corresponding to each LCU in one row can be stored to the memory spaces H0-H5 and later used by a respective adjacent LCU in a next row. Particularly, when processing each of the six LCUs above the tile boundary 217, top neighbor reference data corresponding to those LCUs can be stored to the memory spaces H0-H5. The stored top neighbor reference data can later be used for decoding each of the six LCUs below the tile boundary 217. Similarly, when processing each of the four LCUs to the left of the tile boundary 219, left neighbor reference data corresponding to those LCUs can be stored to the memory spaces V0-V3. The stored left neighbor reference data can later be used for decoding each of the four LCUs to the right of the tile boundary 219.

FIG. 2B shows a decoding process 200B for decoding a tile-based picture 240 in the video decoding system 100 according to an embodiment of the disclosure. The picture 240 can be partitioned into tiles 241-246 and LCUs in a way similar to the picture 210, resulting in tile boundaries 247 and 249. The LCUs in the picture 240 can similarly be indicated each with a pair of picture-based (X, Y) coordinates, and processed in an order as indicated by arrows 248. However, different from the FIG. 2A example, the tiles 241-246 in the picture 240 can be independently encoded. In other words, data references across tile boundaries are not allowed when encoding the picture 240.

Similar to the FIG. 2A example, when processing of a current LCU, some decoding operations may need to use top or left neighbor reference data located in neighboring LCUs (top neighboring LCU or left neighboring LCU). However, as cross tile boundary data reference is not allowed when encoding the tiles 241-246, cross tile boundary data reference will not take place for decoding of the tiles 241-246 accordingly. As a result, two memory spaces H0-H1 in a horizontal memory 250, instead of the six memory spaces H0-H5 in the FIG. 2A example, can be used for storing neighbor reference data for a current tile. The horizontal memory 250 can be the tile-based memory 122 as shown in FIG. 1. In addition, no vertical memory is needed during the decoding process 200B.

For example, when decoding the LCUs (0, 0) and (1, 0) in the tile 241 during the decoding process 200B, top neighbor reference data corresponding to the LCUs (0, 0) and (1, 0) can be stored to the memory space H0-H1 in the horizontal memory 250, respectively. The stored top neighbor reference data can later be used for successively decoding the LCUs (0, 1) and (1, 1). However, as cross tile boundary data reference is not used, when decoding the LCUs (0, 1) and (1, 1), no neighbor reference data is stored to the horizontal memory 250 for use of decoding the next row LCUs (0, 2) or (1, 2). Subsequently, when decoding the LCUs (2, 0) and (3, 0), the memory space H0-H1 can be used for storing top neighbor reference data corresponding to the LCUs (2, 0) and (3, 0). For the vertical memory, as cross tile boundary data reference is not used, when an LCU to the left of the tile boundary 249 is processed, no left neighbor reference data corresponding to this LCU needs to be stored. Accordingly, no vertical memory is used during the decoding process 200B.

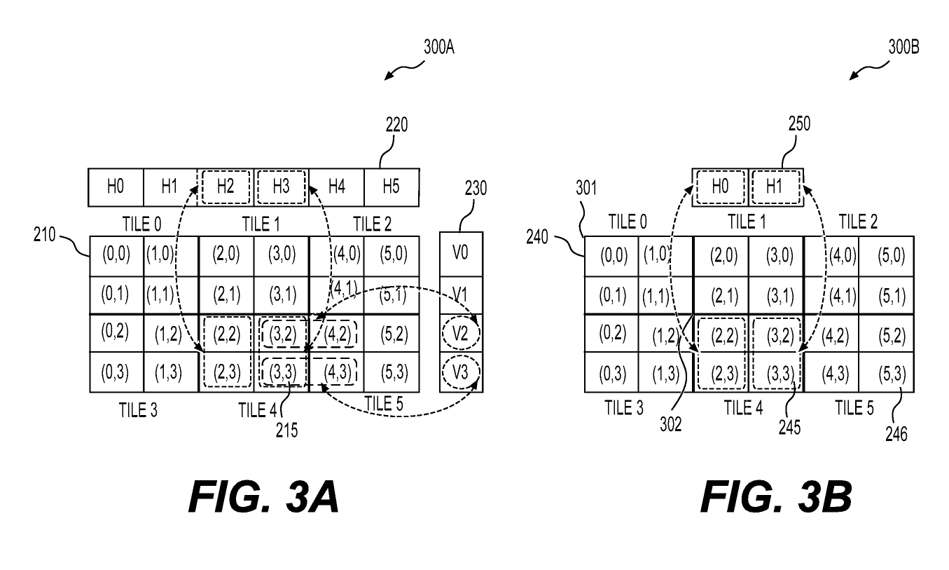

FIG. 3A shows an exemplary memory access scheme 300A in the conventional decoding system described in FIG. 2A example. The memory access scheme 300A can be used to determine a target memory space for access to neighbor reference data during the decoding process 200A. The picture 210, and the horizontal and vertical memories 220 and 230 are shown in FIG. 3A. As similarly shown in FIG. 2A, the LCUs of the picture 210 are each associated with a pair of picture-based (X, Y) coordinates in FIG. 3A.

In the horizontal direction, each memory space H0-H5 corresponds to an LCU column in the picture 210. Accordingly, based on an X coordinate of an LCU, a respective memory space of H0-H5 can be determined. For example, when writing top neighbor reference data of the LCU (2, 2) which has a picture-based X coordinate equal to 2, the memory space H2 can be determined to be the target memory space for the write operation. When decoding the LCU (2, 3) which has a picture-based X coordinate equal to 2, the memory space H2 can be determined to be the target memory space for reading the respective top neighbor reference data. Similarly, the LCUs of (3, 2) and (3, 3) both have a picture-based X coordinate of 3, the memory space H3 can be determined to be the target memory for respective write and read operations.

Similarly, in the vertical direction, each memory space V0-V3 corresponds to an LCU row. Accordingly, based on a Y coordinate of an LCU, a respective memory space of V0-V3 can be determined. For example, when writing left neighbor reference data of the LCUs (3, 2) and (3, 3) which have picture-based Y coordinates of 2 and 3, respectively, the memory spaces V2 and V3 can be determined to be the respective target memory spaces for the write operations. When decoding the LCUs (4, 2) and (4, 3), which have picture-based Y coordinates of 2 and 3, the memory space V2 and V3 can be determined to be the target memory spaces for reading the respective left neighbor reference data.

FIG. 3B shows an exemplary memory access scheme 300B according to an embodiment of the disclosure. The picture 240 and the horizontal memory 250 are shown similarly in FIG. 3B as in FIG. 2B. Each LCU is associated with a pair of picture-based (X, Y) coordinates. As described above, the memory spaces H0-H1 can be used to store top neighbor reference data corresponding to different LCUs in one row of a current tile. The memory access scheme 300B can be performed by the P2T MMU 121 to determine a target memory space for reading or writing top neighbor reference data when an LCU is being processed during the video decoding process 200B.

Specifically, when a current LCU having a pair of picture-based (X, Y) coordinates in a current tile is being processed, top neighbor reference data may need to be write or read from one of the two memory spaces H0 and H1. To facilitate the memory access, a coordinate translation can be performed to obtain a tile-based X or Y coordinate of the current LCU in the following way,

tile-based X coordinate=picture-based X coordinate of current LCU−tile X offset,

tile-based Y coordinate=picture-based Y coordinate of current LCU−tile Y offset,

wherein the tile X offset is a picture-based X coordinate of a start position of the current tile, and the tile Y offset is a picture-based Y coordinate of the start position of the current tile. For example, the tile 245 has a start position 302 that has a pair of picture-based coordinates (2, 2) with respect to a start position 301 of the picture 240. Accordingly, the tile 245 has a tile X offset of 2, and a tile Y offset of 2. Similarly, the tile 246 has a tile X offset of 4, and a tile Y offset of 2. Based on the translated tile-based X coordinate of the current LCU, a target memory space H0 or H1 can be determined.

For example, the LCU (2, 2) of the tile 245 is being processed at one of the multiple modules 112, 113, 117, or 118, and top neighbor reference data corresponding to the current LCU (2, 2) needs to be stored to the horizontal memory 250. Accordingly, the P2T MMU 121 may receive a request from the respective module 112, 113, 117, or 118. The request can indicate what type of access operation (read or write) is to be performed as well as the picture-based X coordinate of the current LCU and a tile X offset of the tile 245. The P2T MMU 121 can then perform a coordinate translation as follows,

tile-based X coordinate=picture-based X coordinate−tile X offset=2−2=0.

Accordingly, the memory space H0 can be determined to be a target memory space for writing the top neighbor reference data corresponding to the LCU (2, 2).

For another example, when the LCU (2, 3) of the tile 245 is being processed, the previously stored top neighbor reference data corresponding to the LCU (2, 2) needs to be retrieved from the horizontal memory 250. A similar coordinate translation can be performed to determine a translated tile-based X coordinate (equal to 0), and accordingly the memory space H0 can be determined to be a target memory space.

For a further example, when reading top neighbor reference data corresponding to the LCU (3, 2) for decoding the current LCU (3, 3), the P2T MMU 121 can perform a coordinate translation as follows,

tile-based X coordinate=picture-based X coordinate−tile X offset=3−2=1,

wherein the picture-based X coordinate of the current LCU (3, 3) is 3. Accordingly, the memory space H1 can be determined to be a target memory space.

While the pictures 240 is fully decoded in the FIGS. 2B and 3B examples, pictures can be partially decoded in alternative examples. Coordinate translations can be performed in a way similar to the FIGS. 2B and 3B examples to determine target memory spaces in the tile-based memory 122 for processing selected tiles.

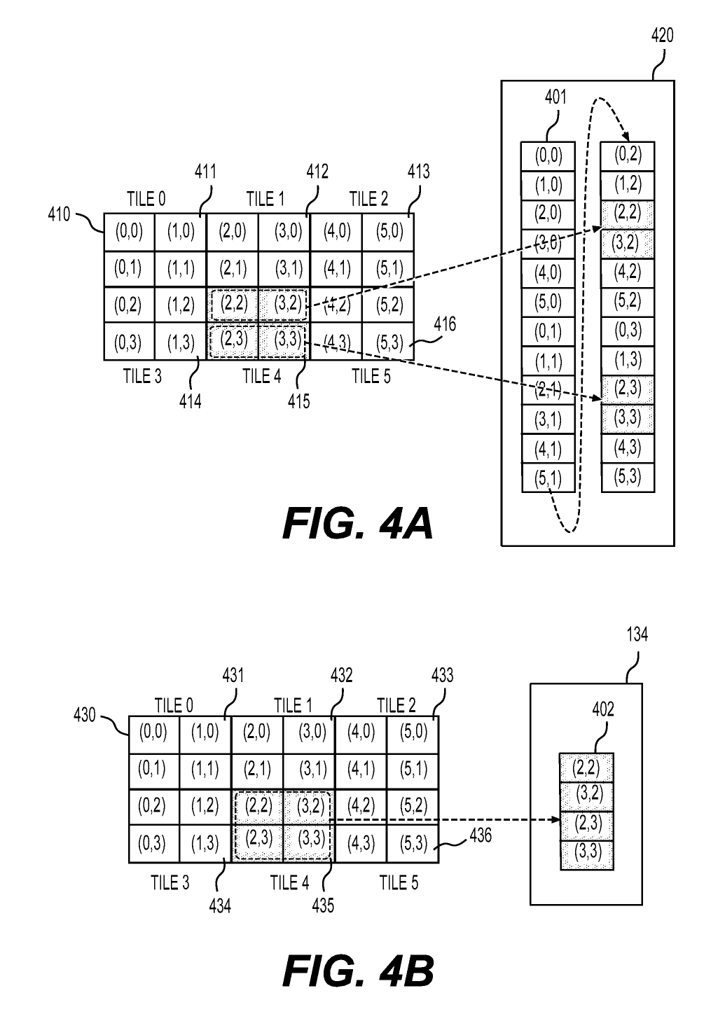

FIG. 4A shows an example of an output memory map 401 of an output memory 420 in the conventional decoding system. As shown, a picture 410 can have a tile and LCU partition similar to that of the picture 210, and include tiles 411-416. All the tiles 411-416 and LCUs have been decoded and stored into the output memory 420 waiting for being displayed. A memory space for holding all the LCUs has a size determined by a resolution of the picture 410. In addition, the LCUs can be arranged in an LCU raster scan order in the memory 420. As a result, the tiles (2, 2), (3, 3), (2, 3), and (3, 3) can be discontinuous in the output memory 420.

FIG. 4B shows an example of an output memory map 402 of the output memory 134 in the video decoding system 100. As shown, a picture 430 can have a tile and LCU partition similar to that of the picture 410, and includes tiles 431-436. However, different from the FIG. 4A example, the tiles 431-436 in the picture 430 can be independently decodable, and accordingly the picture 430 can be partially decoded. In the FIG. 4B example, the tile 435 is selected and decoded, and the LCUs (2, 2), (3, 2), (2, 3), and (3, 3) of the tile 435 are stored into the output memory 134. Thus, a memory space for holding the decoded LCUs (2, 2), (3, 2), (2, 3), and (3, 3) has a size determined by a number of tiles that are selected and decoded. In addition, in one example, decoded LCUs can be arranged in a tile raster scan order in the memory 134. As a result, LCUs in a decoded tile can be group together and arranged continuously in the memory 134. In FIG. 4B, the LCUs (2, 2), (3, 3), (2, 3), and (3, 3) of the tile 435 are shown adjacent to each other on the memory map 402.

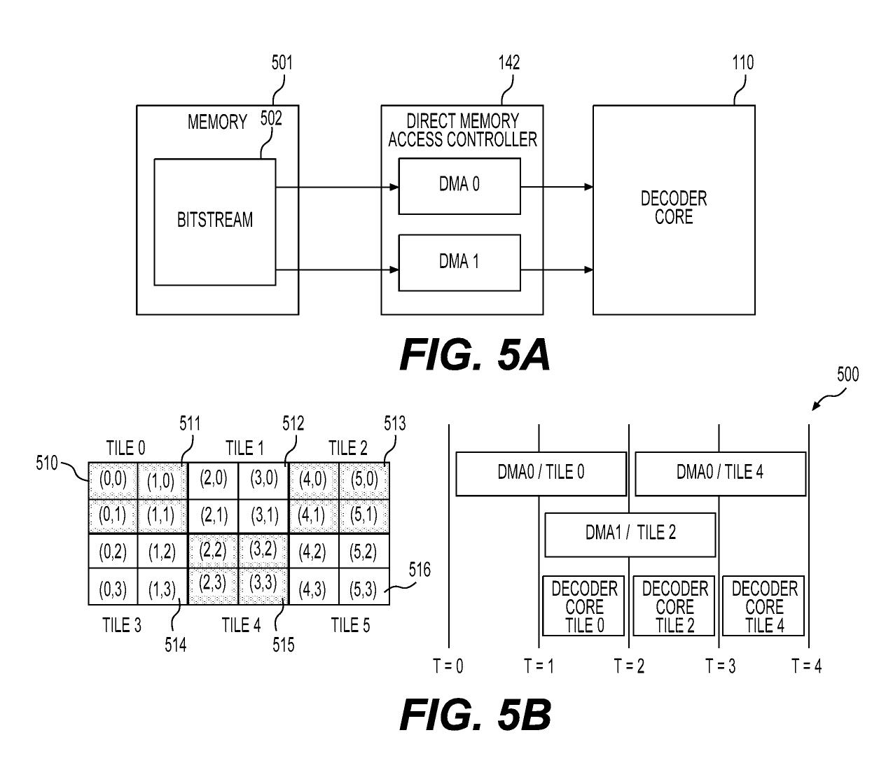

FIG. 5A shows an example DMA controller 142 in the video decoding system 100 according to an embodiment of the disclosure. The DMA controller 142 can include two DMA modules DMA0 and DMA1 that can operate in parallel to read tile data from a bitstream 502 stored in a memory 501 and provide the tile data to the decoder core 110. For example, the memory 501 can be an off-chip memory, and the decoder core 110 can be implemented as on-chip circuitry. Reading tile data in parallel can reduce latency caused by transferring tile data from the off-chip memory 501 to the on-chip decoder core 110.

FIG. 5B shows an example process 500 of reading tile data in parallel by the DMA controller 142. A picture 510 can have a tile and LCU partition similar to that of the picture 210, and include tiles Tile 0-Tile 5 labeled with numbers 511-516. In addition, the tiles 511-516 can be independently encoded, and thus can be selectively and independently decoded at the decoder core 110. In the FIG. 5B example, the decoding controller 111 can determine to decode the tiles 511, 513 and 515 successively, for example, based on HMD FOV information. Accordingly, the two DMA modules DMA0 and DMA1 can be configured to start reading operation alternatively for reading tile data from the memory 501.

Specifically, as shown in FIG. 5B, at time instant T=0, the DMA0 can start to read tile data of Tile 0, and the reading operation continues until T=2. Meanwhile, at time instant T=1, the DMA1 can start to operate to read tile data of Tile 2, and the reading operation continues until T=3. At the same time, the decoder core 110 can start to process Tile 0 at T=1 while the DMA0 is reading the tile data of Tile 0, and subsequently start to process Tile 2 at T=2 while the DMA1 is reading the tile data of tile 2. Similarly, the DMA0 can start to read tile data of Tile 4 following completion of reading Tile 0 data, and the decoder core 110 can start to process Tile 4 at T=3. In this way, tile data can be transferred to the decoder core 110 from the memory 501 through two parallel paths, increasing throughput rate of the video decoding system 100.

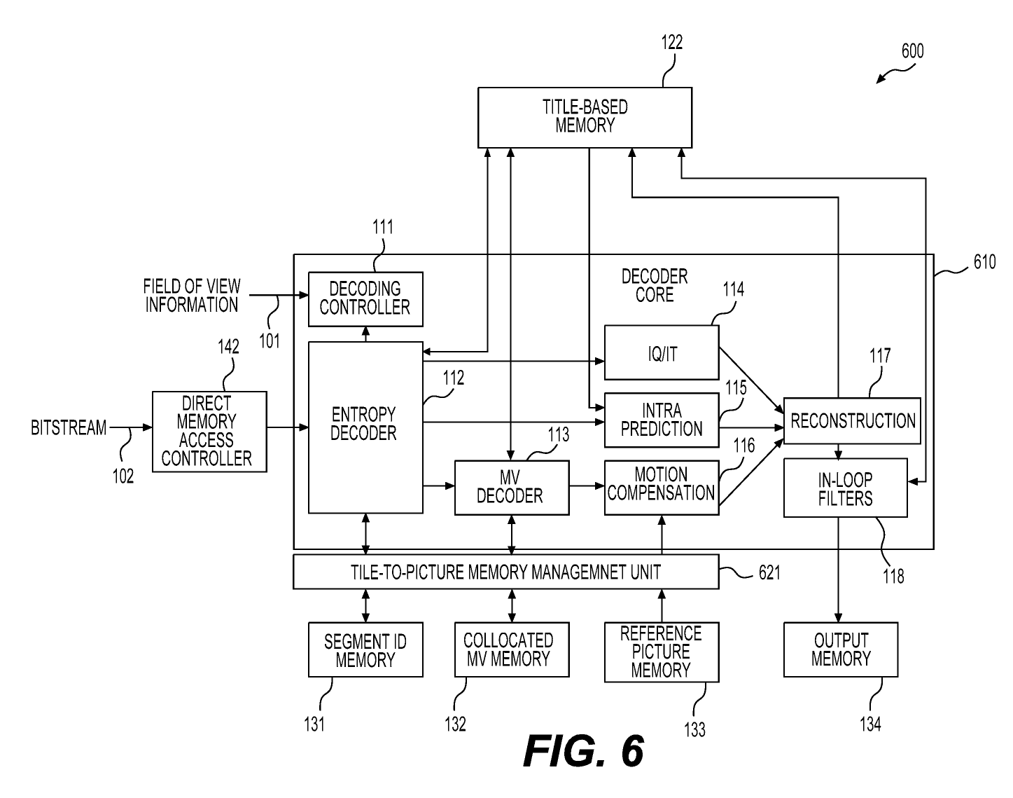

FIG. 6 shows a video decoding system 600 according to an embodiment of the disclosure. The video decoding system 600 can include components similar to that of the video decoding system 100, and operate in a way similar to the video decoding system 100. For example, the video decoding system 600 can include the components 142, 111-118, 122, 131-134 that are included in the video decoding system 100. The video decoding system 600 can include a decoder core 610 that operate in a way similar to the decoder core 110, and partially decoding a picture including independently encoded tiles.

Different from the decoder core 110, the decoder core 610 can operate based on tile-based coordinates. For example, when processing a current tile, LCUs in the current tile can be associated with a pair of tile-based (X, Y) coordinates with a starting position of the tile as an origin. Accordingly, memory access to the tile-based memory 122 can be straightforward, and a target memory space used for storing top neighbor reference data of a current LCU can be determined based on a tile-based X coordinate of the current LCU without a coordinate translation. However, memory access to the segment ID memory 131, the collocated MV memory 132, and the reference picture memory 133 may need to perform a coordinate translation.

For example, the data in the memories 131-133 can be organized based on LCUs, and memory spaces for storing the data can be associated with picture-based (X, Y) coordinate pairs of each LCU, thus can be located based on the picture-based (X, Y) coordinate pairs. Accordingly, the P2T MMU 121 in the video decoding system 100 is removed in the video decoding system 600, and a tile-to-picture memory management unit (T2P MMU) 621 is added between the decoder core 610 and the memories 131-133. The T2P MMU 621 can be employed to translate a pair of tile-based (X, Y) coordinates of a current LCU to a pair of picture-based (X, Y) coordinates. Based on the translated coordinates, access to data corresponding to the current LCU in the memories 131-133 can be realized.

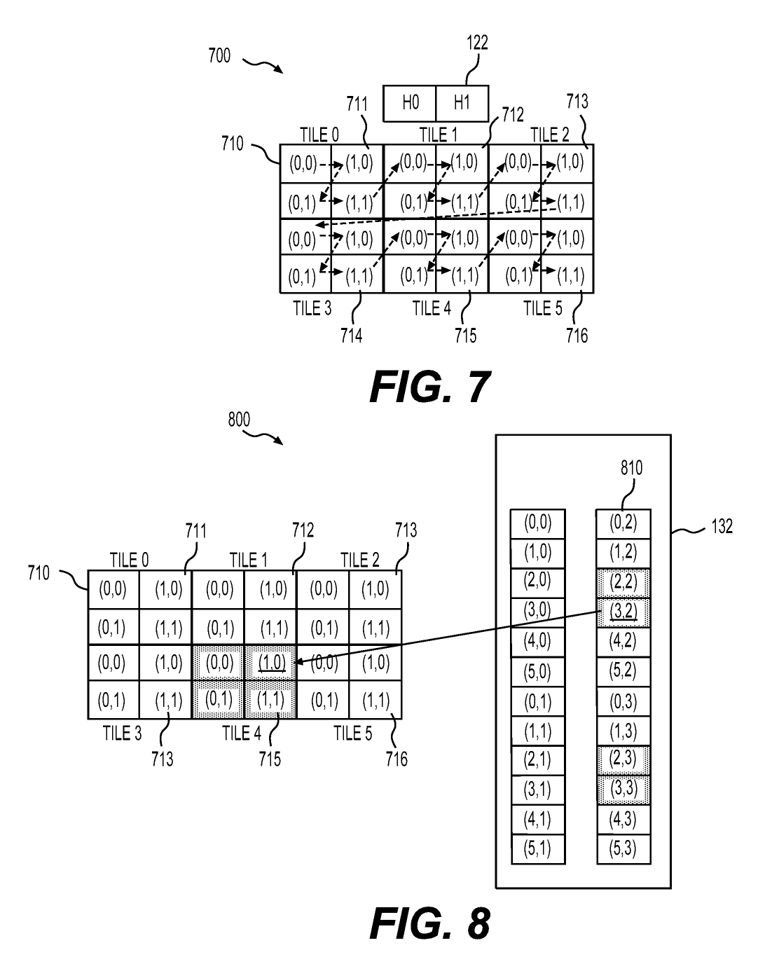

FIG. 7 shows an example decoding process 700 for decoding a picture 710 in the video decoding system 600 according to an embodiment of the disclosure. The picture 710 can be partitioned in a way similar to the picture 240 in the FIG. 2B example, and include tiles 711-716 each including four LCUs. In addition, the LCUs in the tiles 711-716 can be processed in an order similar to that of the picture 240. Each tile 711-716 can be independently encoded, and accordingly can be decoded independently. However, different from the decoding process 200B, tile-based (X, Y) coordinates are used during the decoding process 700 in the video decoding system 600.

Specifically, the LCUs within each tile are each associated with a pair of tile-based (X, Y) coordinates. For example, the four LCUs in the tile 715 can each have a pair of tile-based coordinates (0, 0), (1, 0), (0, 1), and (1, 1), respectively. Similarly, in other tiles, the four LCUs can each have a pair of tile-based coordinates (0, 0), (1, 0), (0, 1), and (1, 1), respectively. When a memory access for writing or reading top reference data into or from the tile-based memory 122 takes place at a current LCU, a tile-based X coordinate of the current LCU can be used to determine a target memory space H0 or H1 in the tile-based memory space 122. While the picture 710 is fully decoded in the FIG. 7 example, pictures can be partially decoded in alternative examples.

FIG. 8 shows a coordinate translation scheme 800 according to an embodiment of the disclosure. The coordinate scheme can be performed at the T2P MMU 621 to translate tile-based (X, Y) coordinates to picture-based (X, Y) coordinates to facilitate memory access to the memories 131-133 in the FIG. 6 example. For example, the LCUs in the picture 710 can each have a pair of tile-based (X, Y) coordinates. Memory spaces in each of the memories 131-133 can be organized based on an LCU basis for storing reference data corresponding to each LCU in the picture 710. When a memory access to one of the memories 131-133 is going to take place while processing a current LCU, the tile-based (X, Y) coordinates of the current LCU can be translated to a pair of picture-based (X, Y) coordinates in the following way,

picture-based X coordinate=tile-based X coordinate+tile X offset,

picture-based Y coordinate=tile-based Y coordinate+tile Y offset,

wherein the tile X or Y offset is an X or Y offset of a tile including the current LCU. Based on the translated picture-based (X, Y) coordinates, a target memory space corresponding to the current LCU can be determined in one of the memories 131-133.

As an example, a memory map 810 of the collocated MV memory 132 is shown in FIG. 8. On the memory map 810, collocated MV data is organized on an LCU basis, and collocated MV data corresponding to each LCU is assigned with a memory space that is associated with a pair of picture-based (X, Y) coordinate of the LCU. When a pair of picture-based (X, Y) coordinates of a current LCU is known, a target memory space can be located.

For example, the tile 715 is being processed in the decoder core 610. The tile 715 has an X offset of 2, and a Y offset of 1, and the four LCUs of the tile 715 have tile-based coordinates, (0, 0), (1, 0), (0, 1), and (1, 1). When the coordinate translation scheme 800 is performed, a set of picture-based coordinates, (2,2), (3, 2), (2, 3), and (3, 3), can be derived. Assuming the MV decoder 113 is processing the LCU (1, 0) of the tile 715, the MV decoder 113 can send a read request to the T2P MMU 621 for reading collocated MV data of a master picture. The request can include the tile-based coordinates (1, 0), and the X and Y offsets of the tile 715. The T2P MMU 621 can perform a coordination translation to obtain the picture-based coordinates (3, 2). Based on the translated coordinates (3, 2), a target memory space associated with the coordinates (3, 2) can be located in the collocated MV memory 132. Similarly, when the MV decoder 113 needs to write MV data of a current LCU, the above coordinate translation process can be performed to determine a target memory space that is subsequently updated.

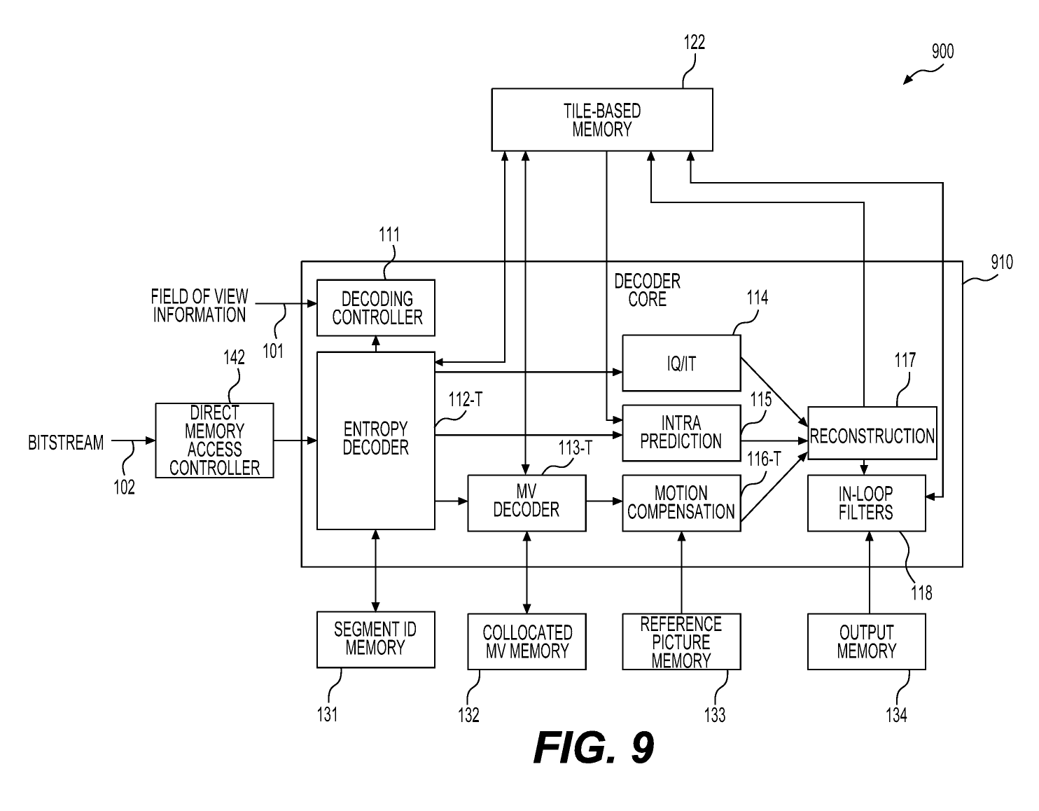

FIG. 9 shows a video decoding system 900 according to an embodiment of the disclosure. The video decoding system 900 is similar to the video decoding system 600 in terms of structures and functions. However, different from the video decoding system 600, the video decoding system 900 does not include the T2P MMU 621. Instead, functions of coordinate translation from tile-based picture coordinates to picture-based coordinates are included in respective modules that initiate read or write memory access requests. Specifically, the entropy decoder 112, the MV decoder 113, and the motion compensation module 116 in the FIG. 6 example are substituted by an entropy decoder 112-T, a MV decoder 113-T, and a motion compensation module 116-T in the FIG. 9 example. The entropy decoder 112-T, the MV decoder 113-T, and the motion compensation module 116-T can be configured to perform the coordinated translation functions performed by the T2P MMU 621.

In addition to the coordinate translation functions, the entropy decoder 112-T, the MV decoder 113-T, and the motion compensation module 116-T can be configured to perform functions similar to the entropy decoder 112, the MV decoder 113, and the motion compensation module 116. Moreover, other components as shown in FIG. 9 can be the same as in FIG. 6.

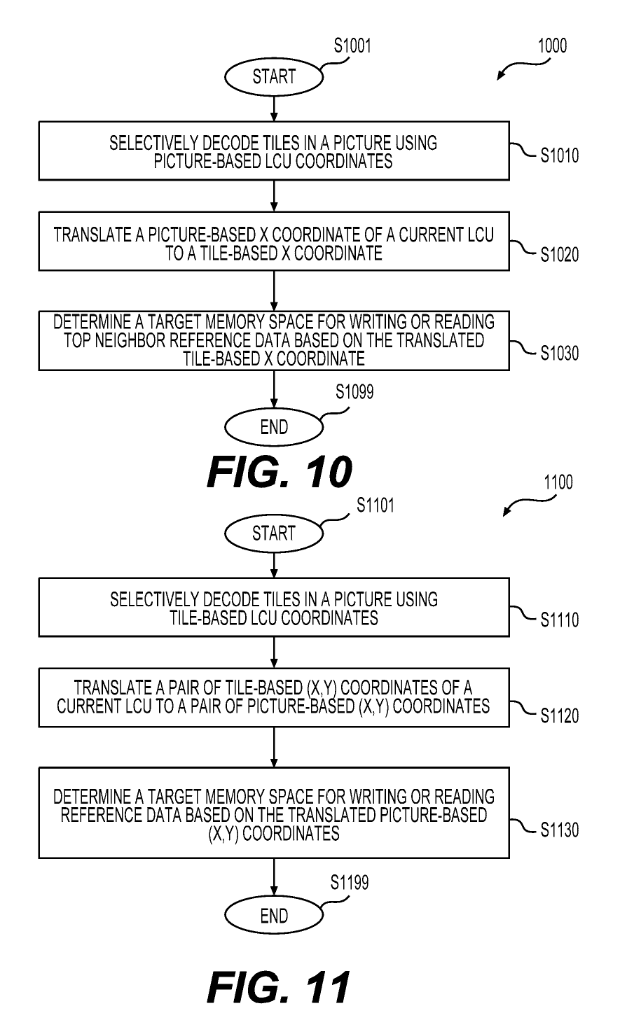

FIG. 10 shows an example video decoding process 1000 according to an embodiment of the disclosure. The video decoding process 1000 can be performed in the video decoding system 100. The video decoding process 1000 can start at S1001 and proceeds to S1010.

At S1010, tiles in a picture can be selectively decoded in the video decoding system 100. For example, the picture can include independently encoded tiles, and thus can be partially decodable. Particularly, picture-based LCU coordinates can be used to indicate each LCU in the tiles of the picture. When decoding a current tile, a plurality of memory spaces in the tile-based memory 122 can be employed to store top reference data corresponding to an LCU row that can later be used for decoding a next LCU row.

At S1020, a picture-based X coordinate of a current LCU in a current tile can be translated to a tile-based X coordinate to facilitate memory access to one of the plurality of memory spaces. For example, a memory access request can be received at the P2T MMU 121 indicating a write or read operation and a pair of picture-based (X, Y) coordinates of a current LCU. The P2T MMU 121 can subsequently perform the translation to obtain the translated tile-based X coordinate.

At S1030, a target memory space can be determined based the translated tile-based X coordinate for writing or reading top reference data. For example, each of the plurality memory spaces can correspond to an LCU column of a tile. Based on the translated tile-based X coordinate, one of the plurality of memory spaces can be determined to be the target memory space for storing top reference data of the current LCU or reading top reference data of a previously processed LCU adjacent to the current LCU. Subsequently, the read or write operation can be completed. The process 1000 proceeds to S1099 and terminates at S1099.

FIG. 11 shows an example video decoding process 1100 according to an embodiment of the disclosure. The video decoding process 1100 can be performed in the video decoding systems 600 or 900. The video decoding process 1100 can start at S1101 and proceeds to S1110.

At S1110, tiles in a picture can be selectively decoded in the video decoding system 600 or 900. For example, the picture can include independently encoded tiles, and thus can be partially decodable. Particularly, tile-based LCU coordinates can be used to indicate each LCU in the tiles of the picture. In addition, reference data corresponding to a previously decoded picture may be used for decoding the current picture. For example, those reference data can include reference picture data stored in the reference memory 133, collocated motion vector data stored in the collocated MV memory 132, or segment IDs stored in the segment ID memory 131. Those reference data can be organized based on an LCU basis, and accordingly may include a plurality of memory spaces each corresponding to an LCU. When the picture is a master picture that is referenced by other slave pictures, some reference data, such as segment IDs, or collocated motion vectors, can be updated by the entropy decoder 112/112-T or the MV decoder 113/113-T while processing a current LCU.

At S1120, a pair of tile-based (X, Y) coordinates of a current LCU in a current tile can be translated to a pair of picture-based (X, Y) coordinates to facilitate memory access to memories storing reference data of previously decoded pictures. For example, a memory access request can be received at the T2P MMU 621 indicating a read or write operation, a pair of tile-based (X, Y) coordinates of a current LCU, a pair of tile X and Y offsets of a current tile including the current LCU, and a memory (such as the memory 131-133) storing reference data of a previously decoded picture. The T2P MMU 621 can subsequently perform the translation to obtain the translated picture-based (X, Y) coordinates.

At S1130, a target memory space can be determined based the translated picture-based (X, Y) coordinates for reading reference data of the previously decoded picture, or writing reference data corresponding to the current LCU. For example, each of the plurality of memory spaces in the memory storing the reference data can correspond to an LCU. Based on the translated picture-based (X, Y) coordinates, one of the plurality of memory spaces can be determined to be the target memory space for the reading or writing operation. Subsequently, the read or write operation can be completed. The process 1100 proceeds to S1199 and terminates at S1199.

In various embodiments, the decoder core 110 and the P2T MMU 121 in the FIG. 1 example, the decoder core 610 and the T2P MMU 621 in the FIG. 6 example, and the decoder core 910 in the FIG. 9 example can be implemented as software, hardware, or a combination thereof. In one example, those components can be implemented as one or more integrated circuits (IC) such as a digital signal processor (DSP), an application specific integrated circuit (ASIC), programmable logic devices (PLDs), field programmable gate arrays (FPGAs), digitally enhanced circuits, or comparable device or a combination thereof. For another example, those components can be implemented as instructions stored in a memory, when executed by a central processing unit (CPU), causing the CPU to the perform functions of those components.

The processes 1000 and 1100, and the functions of the video decoding systems 100, 600, and 900 can be implemented as a computer program which, when executed by one or more processors, can cause the one or more processors to perform steps of the respective processes and functions of the respective video decoding systems. The computer program may be stored or distributed on a suitable medium, such as an optical storage medium or a solid-state medium supplied together with, or as part of, other hardware, but may also be distributed in other forms, such as via the Internet or other wired or wireless telecommunication systems. For example, the computer program can be obtained and loaded into an apparatus through physical medium or distributed system, including, for example, from a server connected to the Internet.

The computer program may be accessible from a computer-readable medium providing program instructions for use by or in connection with a computer or any instruction execution system. A computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium and solid state storage medium.

While pictures including specific numbers of tiles or LCUs are shown in the examples described herein, pictures in alternative examples can have different tile or LCU partitions, and accordingly, different numbers of tiles or LCUs in each picture. For example, a tile may have more than two rows of LCUs, and each such LCU row may have more than two LCUs. However, the functions, schemes, or processes described herein can be applied to any partitions with any number of tiles or rows.

In addition, while examples of certain types of neighbor reference data stored in the tile-based memory 122, and certain types of reference data stored in the memories 131-133 are described herein, other types of reference data may be used in other examples. Accordingly, the functions, schemes, or processes described herein can also be applied to usage of other types of reference data not described herein.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A video decoding system, comprising:
a decoder core configured to selectively decode independently decodable tiles in a picture, each tile including largest coding units (LCUs) each associated with a pair of picture-based (X, Y) coordinates or tile-based (X, Y) coordinates; and
memory management circuitry configured to,
translate one or two coordinates of a current LCU to generate one or two translated coordinates, and
determine a target memory space storing reference data for decoding the current LCU based on the one or two translated coordinates.

2. The video decoding system of claim 1, wherein the memory management circuitry is configured to,
translate a picture-based X coordinate of the current LCU to a tile-based X coordinate according to an expression of
tile-based X coordinate=picture-based X coordinate−tile X offset,
wherein the tile X offset is a picture-based X coordinate of a start position of a current tile including the current LCU.

3. The video decoding system of claim 2, further comprising:
a first memory including a plurality of memory spaces for storing top neighbor reference data of the current tile, each memory space corresponding to an LCU column of the current tile,
wherein the memory management circuitry is configured to determine one of the plurality of memory spaces in the first memory to be the target memory space storing top neighbor reference data for decoding the current LCU according to the translated tile-based X coordinate.

4. The video decoding system of claim 3, wherein the top neighbor reference data of the current tile is not used for decoding other tiles in the picture.

5. The video decoding system of claim 1, wherein the memory management circuitry is configured to,
translate a pair of tile-based (X, Y) coordinates to a pair of picture-based (X, Y) coordinates according to following expressions,
picture-based X coordinate=tile-based X coordinate+tile X offset, and
picture-based Y coordinate=tile-based Y coordinate+tile Y offset,
wherein the tile X offset is a picture-based X coordinate of a start position of a current tile including the current LCU, and the tile Y offset is a picture-based Y coordinate of the start position of the current tile including the current LCU.

6. The video decoding system of claim 5, wherein the memory management circuitry is configured to determine a memory space in one of following second memories to be the target memory space storing the reference data for decoding the current LCU according to the translated picture-based (X, Y) coordinates:
a reference picture memory configured to store a reference picture for decoding the current tile,
a collocated motion vector memory configured to store motion vectors of a collocated tile in a previously decoded picture with respect to the current tile, or
a segment identity (ID) memory configured to store segment IDs of blocks of a previously decoded picture.

7. The video decoding system of claim 5, wherein the decoder core includes a module that includes the memory management circuitry, and is configured to read the reference data for decoding the current LCU from the target memory space.

8. The video decoding system of claim 1, further comprising:
a third memory configured to store selectively decoded tiles of the picture.

9. The video decoding system of claim 1, further comprising:
a first direct memory access (DMA) module and a second DMA module configured to read encoded tile data of different tiles of the picture in parallel from a bitstream of a sequence of pictures,
wherein the decoder core is configured to cause the first and second DMA modules to alternatively start to read the encoded tile data of different tiles.

10. A video decoding method, comprising:
selectively decoding, by a decoder core, independently decodable tiles in a picture, each tile including largest coding units (LCUs) each associated with a pair of picture-based (X, Y) coordinates or tile-based (X, Y) coordinates;
translating one or two coordinates of a current LCU to generate one or two translated coordinates; and
determining a target memory space storing reference data for decoding the current LCU based on the one or two translated coordinates.

11. The video decoding method of claim 10, wherein translating one or two coordinates of a current LCU to generate one or two translated coordinates includes:
translating a picture-based X coordinate of the current LCU to a tile-based X coordinate according to an expression of
tile-based X coordinate=picture-based X coordinate−tile X offset,
wherein the tile X offset is a picture-based X coordinate of a start position of a current tile including the current LCU.

12. The video decoding method of claim 11, wherein determining a target memory space storing reference data for decoding the current LCU based on the one or two translated coordinates includes:
determining one of a plurality of memory spaces in a first memory to be the target memory space storing top neighbor reference data for decoding the current LCU according to the translated tile-based X coordinate, wherein the plurality of memory spaces is configured for storing top neighbor reference data of the current tile, each memory space corresponding to an LCU column of the current tile.

13. The video decoding method of claim 12, wherein the top neighbor reference data of the current tile is not used for decoding other tiles in the picture.

14. The video decoding method of claim 10, wherein translating one or two coordinates of a current LCU to generate one or two translated coordinates includes:
translating a pair of tile-based (X, Y) coordinates to a pair of picture-based (X, Y) coordinates according to following expressions,
picture-based X coordinate=tile-based X coordinate+tile X offset, and
picture-based Y coordinate=tile-based Y coordinate+tile Y offset,
wherein the tile X offset is a picture-based X coordinate of a start position of a current tile including the current LCU, and the tile Y offset is a picture-based Y coordinate of the start position of the current tile including the current LCU.

15. The video decoding method of claim 14, wherein determining a target memory space storing reference data for decoding the current LCU based on the one or two translated coordinates includes:
determining a memory space in one of following second memories to be the target memory space storing the reference data for decoding the current LCU according to the translated picture-based (X, Y) coordinates:
a reference picture memory configured to store a reference picture for decoding the current tile,
a collocated motion vector memory configured to store motion vectors of a collocated tile in a previously decoded picture with respect to the current tile, or
a segment identity (ID) memory configured to store segment IDs of blocks of a previously decoded picture.

16. The video decoding method of claim 10, further comprising:
storing selectively decoded tiles of the picture into a third memory.

17. The video decoding system of claim 10, further comprising:
alternatively starting a first direct memory access (DMA) module and a second DMA module to read in parallel encoded tile data of different tiles of the picture from a bitstream of a sequence of pictures.

18. A non-transitory computer-readable medium storing computer instructions that, when executed by one or more processors, cause the one or more processors to perform a video decoding method, the method comprising:
selectively decoding, by a decoder core, independently decodable tiles in a picture, each tile including largest coding units (LCUs) each associated with a pair of picture-based (X, Y) coordinates or tile-based (X, Y) coordinates;
translating one or two coordinates of a current LCU to generate one or two translated coordinates; and
determining a target memory space storing reference data for decoding the current LCU based on the one or two translated coordinates.

19. The non-transitory computer-readable medium of claim 18, wherein translating one or two coordinates of a current LCU to generate one or two translated coordinates includes:
translating a picture-based X coordinate of the current LCU to a tile-based X coordinate according to an expression of
tile-based X coordinate=picture-based X coordinate−tile X offset,
wherein the tile X offset is a picture-based X coordinate of a start position of a current tile including the current LCU.

20. The non-transitory computer-readable medium of claim 18, wherein translating one or two coordinates of a current LCU to generate one or two translated coordinates includes:
translating a pair of tile-based (X, Y) coordinates to a pair of picture-based (X, Y) coordinates according to following expressions,
picture-based X coordinate=tile-based X coordinate+tile X offset, and
picture-based Y coordinate=tile-based Y coordinate+tile Y offset,
wherein the tile X offset is a picture-based X coordinate of a start position of a current tile including the current LCU, and the tile Y offset is a picture-based Y coordinate of the start position of the current tile including the current LCU.
